(19) United States
(12) Patent Application Publication
(10) Pub. No.: US 2013/0132306 A1
(43) Pub. Date: May 23, 2013

(54) GAME SYSTEM, AND A STORAGE MEDIUM STORING A COMPUTER PROGRAM AND SERVER APPARATUS THEREFOR

(71) Applicants: Masahiko Kami, Minato-ku (JP); Tadanobu Otaki, Minato-ku (JP)

(72) Inventors: Masahiko Kami, Minato-ku (JP); Tadanobu Otaki, Minato-ku (JP)

(21) Appl. No.: 13/812,286

(22) PCT Filed: Jul. 28, 2011
(86) PCT No.: PCT/JP2011/067303

§ 371 Date: Jan. 25, 2013

(30) Foreign Application Priority Data
Jul. 30, 2010 (JP) 2010-172945

(51) Int. Cl. G06Q 30/02

(52) U.S. Cl. CPC G06Q 30/0283
USPC 705/400

(57) ABSTRACT

A game system capable of calculating fees appropriate for a usage state is provided. The game system (1) where a plurality of game machines (2) and a center server (3) are connected via a network (5), and it is possible to divide into plural unit processes, processes to be executed by the center server (3) in relation to a game to be executed at each of the game machines (2), the plural unit processes each being executed selectively upon a requirement from the game machine (2). In the game system (1), provided are a device which counts, for each game machine (2), the number of executions of each unit processes is executed and a device which calculates, based on the count result in a predetermined tally period, a fee for using system (1) in the tally period in a unit of the game machine (2).

### TECHNICAL FIELD

The present invention relates to a game system and the like where a fee can be calculated depending on usage state of a system including a computer.

### BACKGROUND ART

As one form of business for game system, there is a form where an operator of a commercial facility such as a store, by being provided with a game apparatus or game software for a game apparatus from a manager of a game system, is allowed to run the game apparatus in the commercial facility, and the operator collects a fee as a counter value for a game from a user (a player) of a game apparatus to pay a usage fee of the system to the manager from benefit obtained. As a charging system for usage fee of a game apparatus and the like in such a form, adopted since before is a fixed charging system where the manager collects fixed usage fees from the operators, for example, for each unit period (e.g. one month). In recent years, also adopted is a meter charging system where the number of times that a game is played in a game apparatus is counted up and a fee depending on the number of times is collected (for example, patent literature 1). In the game system where the meter charging system is adopted, each time one game is played, game-play history information is recorded, each time the game-play history information is recorded, a game-play count value is incremented, and the usage fee is calculated depending on the game-play count value.
Patent Literature 1: JP2007-268237A.

### SUMMARY OF INVENTION

### Technical Problem

In a conventional game system where the meter charging system is adopted, the minimum unit to be charged is one game, that is, a game range where a user can play as a counter value for a game-play fee the user paid. However, with respect to the meter charging system, there are various kinds of thoughts about what should be relied on to determine the “quantity” as a criterion for determining the fee. As one example, there is one thought that the manager collects fees depending on a usage state of the system. In this case, the charge is not set suitably to the usage state by merely setting one time of game-play as a charging unit. For example, within one time of game, when some options, such as modes, to be selected upon an instruction by a player are prepared and the load of a computer (usage time of CPU or the like) is varied depending on an option selected, it could happen that the usage fee is not always a value reflecting the usage state of the computer. Further, in a case of a game system using a network, varied load could be imposed on a server apparatus for one execution of game. In this case, even though the manager wants to collect a fee from the operator depending on the usage state, it could be impossible to charge in each game apparatus a suitable fee for the usage amount of service from a server apparatus.

The invention was done in consideration of the above conditions, and the aim of the invention is providing a game system and the like where a fee suitable for usage state can be calculated.

### Solution to Problem

A game system of the present invention is a game system in which processes to be executed in relation to a game by a computer are capable of be sectioned into a plurality of unit processes each of which is selectively executed, and the game system comprises: a count device adapted and configured to count the number of executions that each of the plurality of unit processes was executed; and a fee calculation device adapted and configured to calculate, based on a result of count by the count device in a predetermined tally period, a usage fee of the game system in the tally period.

A computer program of the present invention is a computer program for game system being applied to a game system in which processes to be executed in relation to a game by a computer are capable of be sectioned into a plurality of unit processes each of which is selectively executed, and the computer program makes the computer function as: a count device adapted and configured to count the number of executions that each of the plurality of unit processes was executed; and a fee calculation device adapted and configured to calculate, based on a result of count by the count device in a predetermined tally period, a usage fee of the game system in the tally period.

According to the present invention, by a computer, the number of executions the each unit process was executed is counted and based on the result of count, the usage fee is calculated. Thereby, it is possible appropriately reflect the usage state of the system on the usage fee in comparison with prior art where the fee is calculated depending on the number of times that a game was played. Namely, as each unit process is executed upon a selection element such as an instruction from a user of game (a player) or progress procedure of game, there is a frequently-executed unit process and an infrequently-executed unit process. Further, the dispersion of frequency of executing the unit process also varies depending on a facility where the game machine was installed, a user group of game and so on. According to the present invention, by counting the number of executions of each unit process, it is recognized by the computer how degree each unit process is executed while executing the game. Thereby, the present invention makes it possible to determine the usage state of the system more minutely than before and to calculate the fee appropriate to the determination result.

In the present invention, the unit process may be a process to be selected appropriately upon the selection element and executed by a computer. For example, the unit process could be a group of collected processes for realizing a game mode which is executed by a selection of a user. Alternatively, the unit process could be a group of collected processes each of which is required to a server apparatus by an instruction of a user or by following determination of the game apparatus itself, and is executed by the server apparatus upon the requirement. Additionally, the unit process may be sectioned by another appropriate aspect. The conception of usage fee of system can be recognized as the usage fee of the game apparatus, in a case that the game apparatus is operated in a stand-alone manner. In a case of game system using a network, as one example, the usage fee of the system can be recognized as the usage fee of the server, or the usage fee of service provided by the server apparatus.

In one aspect of the present invention, the fee calculation device may be adapted and configured to calculate a usage amount of each unit process in the tally period based on the number of executions of each unit process counted by the count device and weighed value set for each unit process, and calculate the usage fee based on a value tallied up with respect to the usage amount. Thereby, it is possible to reflect a condition of each unit process with respect to fee setting on the weighed value to set the usage fee. The weighed value may be set by following an arbitrary criterion. As one example, the weighed value may be set so that a difference between the unit processes in a load of the computer is compensated for. Thereby, even if there is a difference between unit processes in a load of computer, it is possible to equalize the load, and reflect appropriately the usage amount of the computer for executing each unit process on the usage fee. The conception of compensation is not limited to a case that a difference in the load is diminished, and also includes a case that the difference is reduced. The load can be represented by, as one example, time necessary for the computer to treat the load, data amount to be treated or the like.

In the present invention, the fee calculation device may be adapted and configured to calculate, based on the value tallied up with respect to the usage amount, the usage fee so that the usage fee becomes higher as the value tallied up increases. Further, the fee calculation device may be adapted and configured to, in a case the value tallied is a predetermined lower limit value of lower of lower, fix the usage fee to the lower limit value, and in a case the value tallied exceeds a predetermined upper limit value, fix the usage fee to the upper limit value.

As one embodiment of the present invention, the game system may include a game apparatus and a server apparatus connected with each other via a network, each of the unit processes may be a process which a computer of the server apparatus selectively executes by following a requirement from the game apparatus. According to this embodiment, by following the requirement from the game apparatus, the number of executions of the unit process by the computer of the server apparatus is counted, and based on the count result, the usage fee of the system with respect to the game apparatus is calculated. In this embodiment, the count device may be provided to the game apparatus or provided to the server apparatus.

In the above embodiment, the network may be connected with a plurality of game apparatuses, the count device may be adapted and configured to count the number independently of each game apparatus, and the fee calculation device may be adapted and configured to calculate the usage fee for one unit of the game machine. By counting the number of executions for each game apparatus and calculating the usage fee, it is possible to calculate the usage fee appropriate for the usage state of the system independently for each game apparatus. Further, the plurality of game apparatuses may be installed to each of a plurality of groups as charged objectives, and the fee calculation device may be adapted and configured to tally up the usage fee for each of the plurality of groups. Thereby, the usage fee can be calculated in a unit of group.

The present invention may be realized as a server apparatus for game system in which processes to be executed in relation to a game by a computer are capable of be sectioned into a plurality of unit processes each of which is selectively executed, and the server apparatus comprises: a count device adapted and configured to count the number of executions that each of the plurality of unit processes was executed; and a fee calculation device adapted and configured to calculate, based on a result of count by the count device in a predetermined tally period, a usage fee of the game system in the tally period. According to the server apparatus of the present invention, it is possible to calculate the usage fee of each of the plurality of game apparatuses appropriately for the state that a computer was used by each game apparatus.

### Advantageous Effects of Invention

As explained above, according to the present invention, processes executed by a computer in relation to a game are divided into plural unit processes, and the number of executions of each unit process is counted. Because of this, it is possible to recognize how degree each unit process is executed by the computer. Thereby, it is possible to determine the usage state of the system more minutely than before, and possible to calculate the usage fee appropriately for the determination result.

### BRIEF DESCRIPTION OF DRAWINGS

FIG. 1 is a diagram showing a summary configuration of a game system according to one embodiment of the present invention

FIG. 2 is a functional block diagram of a control system in a game machine and a center server shown in FIG. 1

FIG. 3 is a diagram showing one example of relation between procedures of game using a network and processing for calculating a usage fee of game system correlated with the execution of the game.

FIG. 4 is a diagram showing one example of ID table

FIG. 5 is a diagram showing one example of usage amount table.

FIG. 6 is a diagram showing one example of event count table

FIG. 7 is diagram showing one example of charge data

FIG. 8 is a flow chart showing procedures of an event counting process

FIG. 9 is a flow chart showing procedures of a charge tallying process.

### DESCRIPTION OF EMBODIMENTS

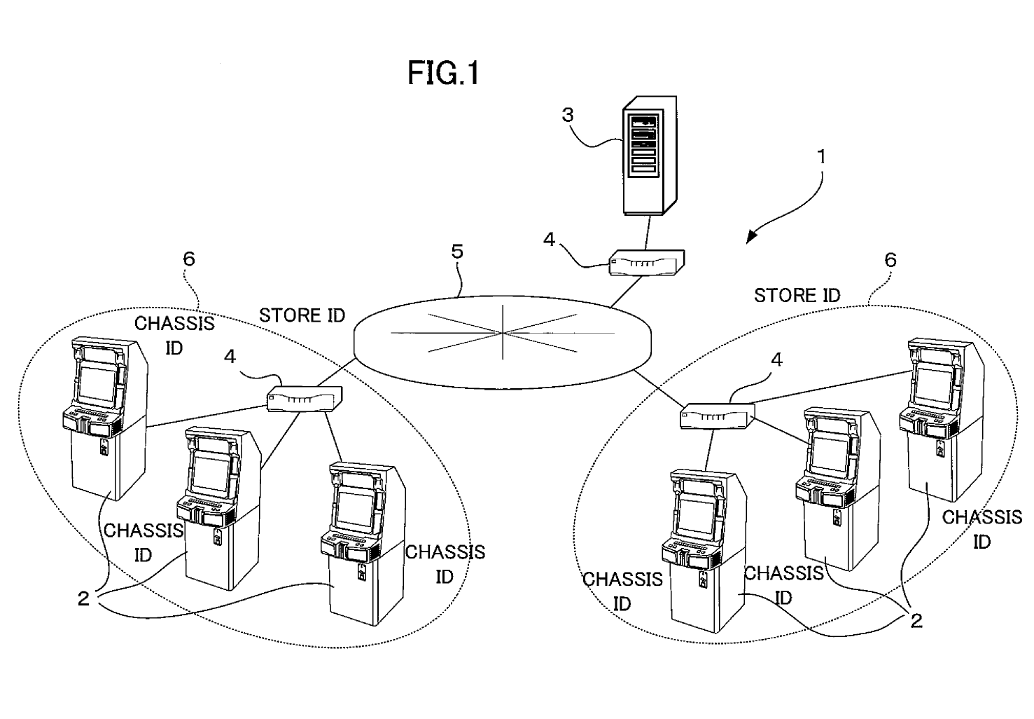

Hereinafter, one embodiment that the present invention is applied to a game system using a network will be explained. FIG. 1 is a schematic of a configuration of a game system according to the present embodiment. In the game system 1, a plurality of game machines (game apparatuses) 2 and a center server (a server apparatus) 3 are connected to a network 5 via routers 4 respectively. The center server 3 is not limited to one physical apparatus, and the center server 3 can be configured as one logical center server 3 by plural servers as plural physical apparatuses. One game machine 2 can be used also as the center server 3. The network 5 realizes a network communication by using the TCP/IP protocol. Typically, the internet is used as the network 5. Each game machine 2 is configured as a game machine for business use or for commercial use which collects a game-play fee as a counter value for a game. An appropriate number of game machines 2 are installed in each commercial facility such as a store 6. The content of game executed at each game machine 2 can be determined arbitrarily. A Game can be different between the game machines 2. The router 4 is installed and correlated with each store 6 or the center server 3. The game machines 2 within the same store are connected with the network 5 via a common router 4. The game machine 2 may be connected to be able to communicate with the center server 3 via a local server, which is installed between the game machine 2 and the router 4 of the store 6. In the game system 1 of the present embodiment, the amount that the game machine 2 in each store 6 used service of the center server 3 (sometimes referred to simply as a usage amount of center server 3) is tallied up for each predetermined tally period as a system usage amount, the usage fee of system is calculated for each store 6 based on the tallied value, and the value of the usage fee is charged on an operator (a seller) of each store 6. Each store 6 corresponds to one group as a charged objective.

The center server 3 is provided by a manager of the game system 1, and provides the game machine 2 or a user of the game machine 2 (sometimes referred to as a player) with various kinds of service via the network 5. As one example, the center server 3 provides the following services: updating service for updating a game program or game data via the game machine 2; service for verifying a user of the game machine 2 by storing player data including game-play history, saved data and the like of the user in the center server 3 and providing the player data to a game machine 2 upon a requirement from the game machine 2; and matching service for users which is necessary to progress a game where the users battle or cooperate with each other via the network 5.

To each of the game machine 2 and the center server 3, an IP address is given, the IP address being unique to identify each of the game machine 2 and the center server 3 in the network 5. For the communication between the game machines 2 or between the game machine 2 and the center server 3, a communicating party is specified by using the IP address. In a case that the network 5 is a network having openness like the internet, a fixed address unique in the network 5 is set to each router 4. A private address, which is combined with the fixed address to identify uniquely each game machine 2 in the network 5, is given as the IP address to a game machine 2. In this case, a virtual private network (VPN) is configured between the game machine 2 and the center server 3 or between the game machines 2, and each of the game machines 2 is uniquely identified using the private address in the VPN. Hereinafter, the fixed address given to the router 4, that is, information for uniquely identifying each store 6 is sometimes referred to as “a store ID”, and the private address given to the game machine 2, that is, information for uniquely identifying each game machine 2 is sometimes referred to as “a chassis ID”.

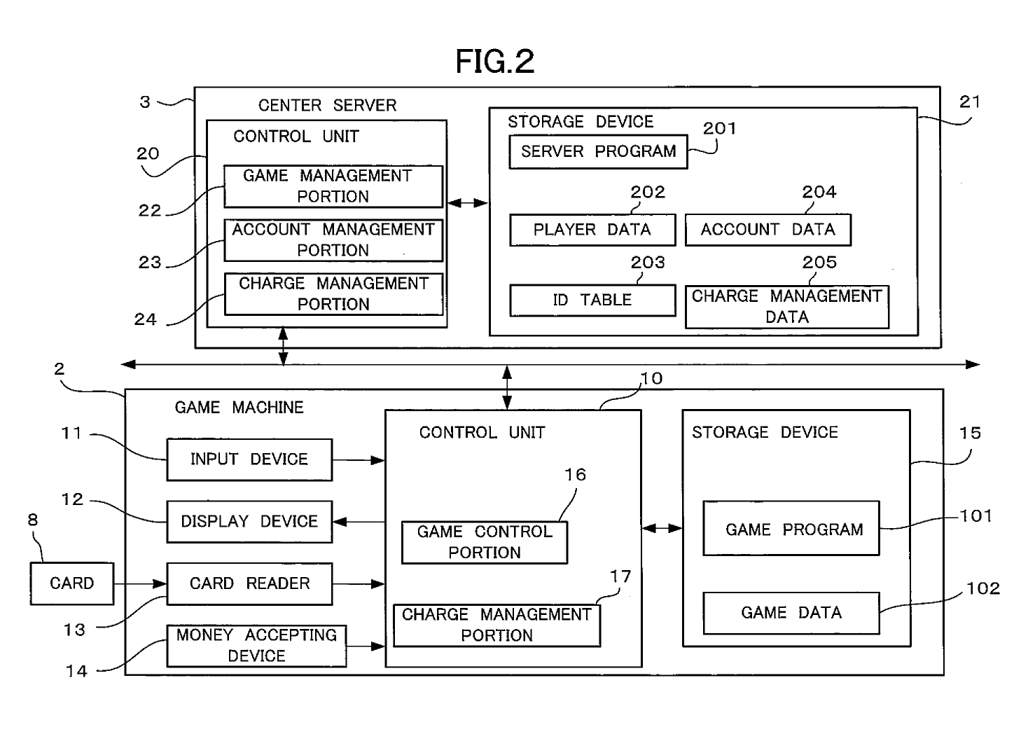

Next, the configuration of a control system in the game system 1 will be described in reference to FIG. 2. In the game machine 2, a control unit 10 is provided. To the control unit 10, an input device 11, a display device 12, a card reader 13, a money accepting device 14, and a storage device 15 are connected. The input device 11 accepts operations by a user and outputs to the control unit 10 signals depending on contents of the operations. The display device 12 displays a game image and the like in accordance with instructions from the control unit 10. The card reader 13 retrieves information from a card 8 possessed by a user and outputs signals corresponding to the information to the control unit 10. In the card 8, a non-volatility memory medium such as an IC chip or a magnetic stripe is provided. In the memory medium, an ID unique for each card 8 (hereinafter, sometimes referred to as “a card ID”) and the like are recorded. The card ID may be recorded in a form of the bar code or the like. The money accepting device 14 detects a value of money (coins or paper money) entered by a user, and outputs signals to the control unit 10 depending on the value entered. The storage device 15 is a storage device capable of maintaining memories such as a hard disk storage device. The storage device 15 stores various kinds of data such as a game program 101 which makes the control unit 10 execute a predetermined game and game data 102 to which the game program 101 refers as necessary in order to progress the game.

The control unit 10 retrieves and executes the game program 101 stored in the storage device 15. Thereby, a game control portion 16 and a charge management portion 17 are provided as logical devices inside the control unit 10. The game control portion 16 executes various kinds of processes necessary for playing a game, such as management of start, progress, and end of a game provided to a user at the game machine 2. The charge management portion 17 executes processes relating to collection of a game-play fee, such as a requirement of paying the game-play fee to the user, and a determination whether the required value of game-play fee was collected. In the present embodiment, as means that a user pays a game-play fee (payment methods), one of two kinds of payment methods can be selected. One payment method is that the game-play fee is paid in cash using the money accepting device 14, and another payment method is that electronic money is withdrawn from an account managed by the center server 3. However, with respect to the minimum unit (the minimum value) of payment value, the payment method with electronic money is smaller than the payment method with real cash. For example, while 100 yen is the minimum unit of real cash, a value corresponding to 1 yen unit is payable with electronic money.

In the center server 3, a control unit 20 and a storage device 21 are provided. The control unit 20 is a computer unit having a microprocessor and an inner storage device (not illustrated), such as a RAM, which provides a work area to the microprocessor. An input device such as a key board and an output device such as a monitor are connected to the control unit 20, but the illustrations of them are omitted. The storage device 21 stores a server program 201 to be executed by the control unit 20 and various kinds of data the program 201 referred to. In the storage device 21, player data 202, an ID table 203, account data 204 and charge management data 205 are stored as data to be referred to by the control unit 20.

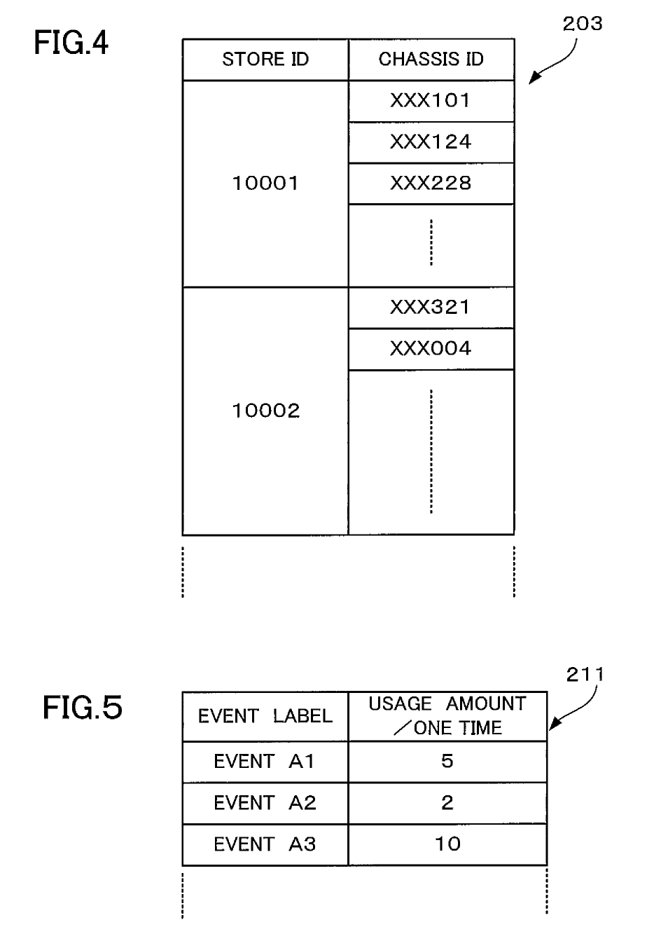

The player data 202 is an assembly of records. In each record, information relating to game-play contents of the player is recorded in association with the card ID of the card 8 possessed by the player, the information including the player's attribute (his/her name, age, gender and the like), the player's game-play history, and the player's score. The ID table 203 is a data table in which the store ID and the chassis ID are correlated with each other. That is, the ID table 203 is data for determining a store 6 which each game machine 2 was installed to. The specific example of the ID table 203 is shown in FIG. 4. In this example, the chassis IDs “XXX101”, “XXX0124”, and “XXX228” are correlated with the store ID “10001”, and the chassis IDs “XXX321” and “XXX004” are correlated with the store ID “10002”. The “X” indicates an arbitrary code such as a numeral or a letter. Additionally, the store ID is also merely represented as one example.

The account data 204 is an assembly of records. In each of the records, the value of electronic money possessed by a user is recorded in association with the ID uniquely given to the user (hereinafter, referred to as a user ID). The card IDs and the user IDs are correlated with each other one on one or many on one. In the storage device 21 of the center server 3, data for discriminating the correlation between the card ID and the user ID is also stored. It is possible for a user to increase (deposit to) the value of electronic money held in the account data 204 via a web site operated by the manager of the system 1 or the like. The deposit of electronic money is charged on the user independently by means of settlement means, for example, by using a credit card or the like. Alternatively, the following embodiment can be applied. By using a deposit terminal for electronic money or the like, the electronic money is deposited in exchange of real cash. As the deposit and settlement of electronic money to the account data 204 can be the same as the deposit and settlement in a prepaid-type electronic money system, detail explanation is omitted. Further, the function relating to the collection of fee with electronic money can be realized by an apparatus separated physically from the center server 3. The charge management data 205 is data necessary for tallying up the amount that each game machine 2 used the center server 3 and charging on each store 6 a fee depending on the usage amount of the center server 3. A detail of the charge management data 205 will be described later.

The control unit 20 retrieves and executes the server program 201 stored in the storage device 21. Thereby, inside of the control unit 20, a game management portion 22, an account management portion 23, and a charge management portion 24 are provided as logical apparatuses. The game management portion 22 executes processes necessary to provide a predetermined game to a player via the network 5, the processes including such as processes of: combining players of the game machines 2 and informing the result to each of the game machines 2; transmitting the player data 203 to the game machine 2; and updating the player data 203 based on information transmitted from the game machine 2. The account management portion 23 is in charge of processes relating to management of electronic money, the processes including processes of withdrawing, upon a withdrawal requirement of the game-play fee transmitted from the game machine 2, a specified value of electronic money from a record (corresponding to the user ID) of the account data 204. That is, in a case that the withdrawal process is required showing the card ID and the payment value from the game machine 2, the account management portion 23 specifies a user ID record corresponding to the card ID from the account data 204, and subtracts the payment value from the value held in the record specified. Thereby, the account management portion 23 completes the payment of the game-play fee with the electronic money. The charge management portion 24 executes the processes of: calculating the usage amount of the center server 3 within a predetermined tally period for each game machine 2, in reference to the charge management data 205; and calculating for each store 6 a usage fee (sometimes referred to as a usage value or a charged value) the value of which depends on the usage amount.

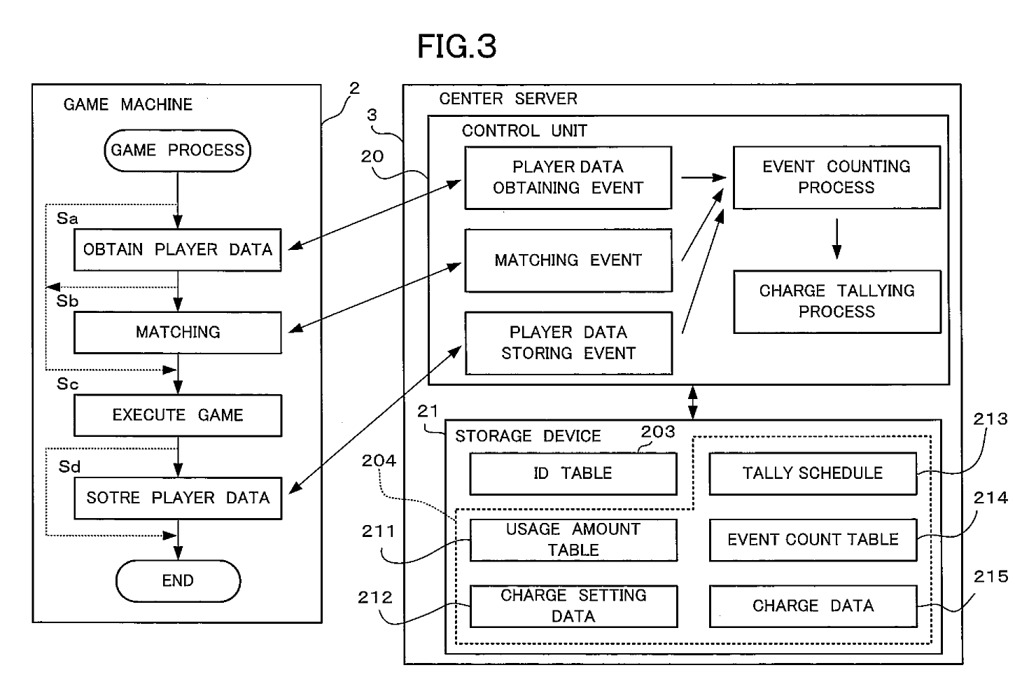

Next, the procedure of calculating the usage value will be described, the procedure being realized mainly by the charge management portion 24. FIG. 3 shows one example of relation between the procedure of game using the network 5 and the processes of calculating the usage fee of the game system 1 relating to the execution of the game. Specifically, here, the usage fee is the usage fee of various kinds of service provided by the center server 3 (hereinafter, sometimes referred to merely as the usage fee of the center server 3). In the example illustrated, first, at the game machine 2, by following user's instruction, the player data 202 correlated with the card ID is obtained from the center server 2 (step Sa). Subsequently, by following instructions from the user, the matching process is executed so that the user is combined with another user becoming a companion who plays a game as an opponent or a cooperator in the game (step Sb). After that, the game is executed by the users combined (step Sc). A game range where the users are permitted to play the game is set depending on the value of game-play fee. When the game of the game range is completed, by following the user's instruction, the player data 202 is stored in the center server 3 (step Sd).

The above mentioned processes in the game machine 2 are one example. As shown with broken lines in FIG. 3, obtaining the player data 202 (step Sa), the matching process (step Sb), and storing the player data 202 (step Sd) are selective, or arbitrary processes which are executed by user's instructions. For example, in a case that a user does not want to continue the game using the player data 202, or in a case that the player data 202 is not stored, the process of step Sa is not executed. In a case that the user does not want to play a game using the network 5 and wants to play a game at the game machine 2 independently, that is, in a stand-alone mode, the process of step Sb is skipped. In a similar way, in a case that the user does not want to store the player data 202, the process of step Sd is skipped.

With the progress of the above mentioned game in the game machine 2, various kinds of processes (sometimes referred to as an event) are retrieved and executed at the center server 3. For example, in a case that it is required from the game machine 2 to provide the player data (step Sa), in response to this, a player data obtaining event is executed. In the player data obtaining event, the player data 202 corresponding to the card ID transmitted from the game machine 2 is obtained from the storage device 21, and the player data 202 is transmitted to the game machine 2. In a case that the matching process is required from the game machine 2 (step Sb), in response to this, a matching event is executed. In the matching event, in reference to the user's attribute, game score and so on transmitted from the game machine 2, another user who matches a predetermined matching condition is searched, and the search result is transmitted to the game machine 2. In a case that it is required from the game machine 2 to store the player data 202 (step Sd), in response to this, a player data storing event is executed. In the player data storing event, based on information indicating a game-play result transmitted from the game machine 2, the player data 202 corresponding to the card ID of the user is updated.

Each of the events is set as an event as a charged objective (the objective from which a usage fee is collected) in the center server 3. The processes of steps Sa, Sb, Sc in the game machine 2 are selective processes to be executed upon instructions from the user. Accordingly, each event of the center server 3 is also a selective process to be executed upon instructions from the user. At the center server 3, each time the event for the charged objective is executed, an event counting process is executed. The event counting process is a process of counting for each chassis ID the number of times each event set as the charged objective was executed. The number of executions of each event is counted as a basis for calculating a usage fee.

Additionally, in the center server 3, based on the result of the event counting process, a charge tallying process is executed. The charge tallying process is a process of calculating for each store 6 the usage value of the center server 3 in a predetermined tally period. These processes are executed by the control unit 20 which uses the charge management portion 24. Detail procedure thereof will be described later. One event corresponds to a unit process consisting of gathered processes which are selectively executed by the control unit 20 upon a requirement from the game machine 2. How wide should be set as a range of one event, in other words, a section of the process unit may be determined arbitrarily depending on a state of the game system 1. For example, in a case that plural modules are prepared in the server program 201 corresponding to plural kinds of services possible to be provided by the center server 3 respectively, the module may be considered as the unit process to section processes. Alternatively, one service is further sectioned into plural events, and each of the events may be treated as one unit process.

In the storage device 21 of the center server 3, the above mentioned ID table 203 and the charge management data 204 are stored as data to be referred to in the event counting process or the charge tallying process. The charge management data 204 includes the usage amount table 211, the charge setting data 212, a tally schedule 213, the event count table 214, and the charge data 215. As one example shown in FIG. 5, in the usage amount table 211, the usage amount of the center server 3 at the moment when the event as the charged objective is executed once (hereinafter, sometimes referred to as a unit usage amount) is recorded by being correlated with an event label (information such as letters and numerals for discriminating each event). The usage amount table 211 is prepared by the following reasons. The burden (for example, the usage time of the CPU included in the control unit 20) of the center server 3 processing each event is different depending on the content of the event. Accordingly, in a case that a usage fee is calculated regarding the number of executions of the event as the usage amount of the center sever 3, the value of the usage fee does not always reflect a substantial usage amount of the center server 3. Then, in order to compensate the difference between events in the load of the control unit 20 for each event, a unit usage amount is set for each event and by multiplying the number of executions of event by the unit usage amount, the difference between events in the load of the control unit 20 is compensated. Thereby, it is possible to convert, with respect to each event, the number of executions of the event into a substantial usage amount of the center server 3. In this way, the unit usage amount is set as a weighed value for converting each event as the unit process into the usage amount of the control unit 20.

The charge setting data 212 shown in FIG. 4 is data where a correlation between the usage amount of the center server 3 and the usage value is recorded. As one example, the relation between the usage amount and the usage value may be set as follows. Until the usage amount attains a predetermined lower limit value X1, the usage value is fixed to the lower limit value, and when the usage amount exceeds a predetermined upper limit X2, the usage amount is fixed to the upper limit. When the usage amount exists between the lower limit X1 and the upper limit X2, the usage fee increases in accordance with the usage amount. The charge setting data 212 is data where such relation is recorded. The charge setting data 212 may be common in all game machines 2, or different charge setting data 212 may be prepared for each store 6. Further, depending on the content of game which is executed in the game machine 2, different kinds of charge setting data 212 from each other may be prepared. The lower limit value functions as the minimum fee for using the center server 3, and the upper limit value functions as the maximum fee for using the center server 3. By setting the lower limit value, it is ensured that the manager of the game system 1 receives a minimum counter value in exchange of providing service to each game machine 2. On the other hand, by setting the upper limit value, with respect to operating each game machine 2, there is no possibility that a usage fee increases unlimitedly. However, the charge setting data 212 is not limited to the one having the lower limit value and the upper limit value as mentioned above, and can be varied appropriately. Either one of the upper limit value or the lower limit value may be set, and both of them may be omitted. Instead of not increasing in accordance with a usage amount, the metered fee may increase in a stepwise manner. The charge setting data 212 should be set so that the maximum value of usage fee of the center server 3, which could occur in one game, does not exceed a game-play fee which is collected from a user for one time game-play. This is for ensuring the benefit of the operator of store 6.

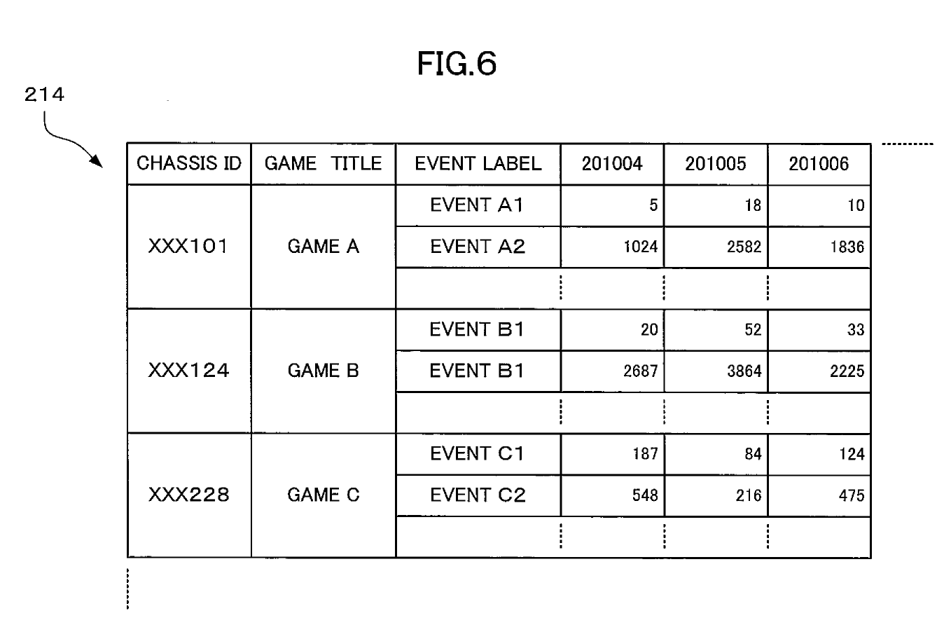

The tally schedule 213 shown in FIG. 4 is data where a tally schedule of the usage value is recorded for each store 6. For example, the tally schedule 213 is set in such a way that the end of every month is set a deadline to tally up the usage fee for every month, or the 15^{th} of every month is set as a deadline to tally up the usage fee for every month. The event count table 214 is data where the number of executions of an event, counted in the event counting process, is written. One example of the event count table 214 is shown in FIG. 6. In this example, for each chassis ID, the game title which is executed, the event label, and the number of executions of the event for each tally period are recorded. For example, with respect to a record corresponding to the chassis ID “XXX101”, the game title is “game A”, and the monthly number of executions of each of the events A1, A2 . . . in the game is recorded.

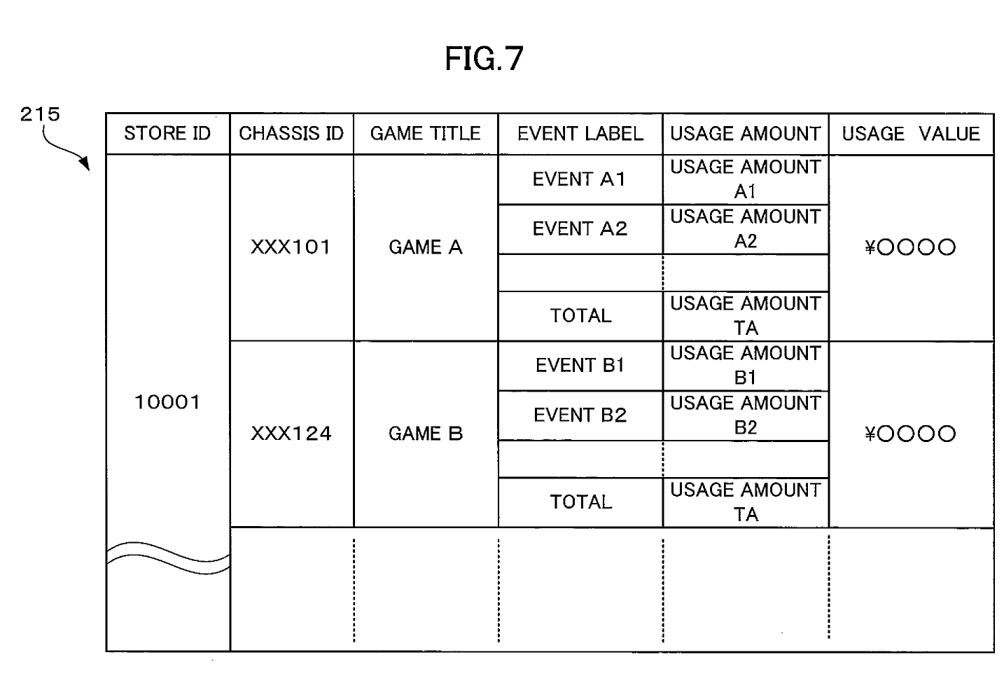

The charge data shown in FIG. 4 is data where the tally result by the charge tallying process is written. One example of the charge data 215 is shown in FIG. 7. In this example, the chassis IDs are collected for each store ID, and the game title, the event label, the usage amount and the usage value are recorded for each chassis ID. For example, in the data with respect to the store ID “10001”, the following information is recorded. The chassis IDs “XXX101”, “XXX124” are correlated to the store ID “10001” in the ID table 203. For each chassis ID, the game title “game A”, and the event labels “event A1”, “event A2” . . . which could be executed in the game are recorded. For each event, each usage amount A1, A2 . . . of the event, and a total usage amount TA which is a total of the usage amounts A1, A2 . . . are recorded. Further, the usage value calculated in regard to the total usage amount TA is recorded.

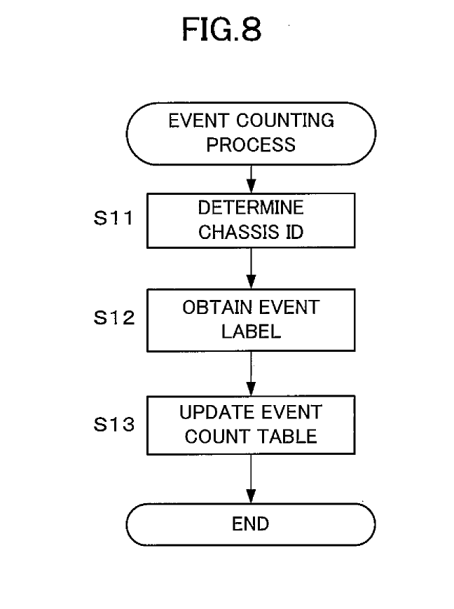

Next, the procedure of the event counting process and the charge tallying process will be described. FIG. 8 shows the procedure of the event counting process. This process is executed each time when the control unit 20 of the center server 3 treats an event as the charged objective by following a requirement from the game machine 2. First, when starting the event counting process, the control unit 20 determines the chassis ID of the game machine 2 which required an event at step S11. Subsequently, at step S12, the control unit 20 obtains a label of the event which was required to be treated. In the example shown in FIG. 4, in a case that the game machine 2 requires the matching process (step Sb), and the control unit 20 of the center server 3 treats the matching event upon the requirement, the chassis ID of the game machine 2 which required the process and the label of the event are obtained at steps S11, S12 in order. When the game machine 2 requires a certain process to the center server 3, the chassis ID is always transmitted from the game machine 2 to the center server 3. Also, when the control unit 20 of the center server 3 determines the requirement from the game machine 2, the event label can be specified.

Subsequently at step S13, the control unit 20 updates the event count table 214 depending on the result of steps S11 and S12. That is, the control unit 20 specifies the record corresponding to the chassis ID obtained at step S11, and in the record specified, adds 1 to the number of executions (the number of times with respect to the latest tally period) of the event corresponding to the event label obtained. After that, the event counting process for one time event is terminated. In a case that an event as the charged objective and an event as not charged objective are included in the events the center server 3 should treat, the processes shown in FIG. 8 are executed only when the event as the charged objective occurs. With respect to the determination of the charged objective, the game machine 2 may execute this determination and transmit information indicating the result (as one example, a charged objective flag) to the center server 3. Alternatively, the center server 3 itself may determine whether the event is the charged objective or not.

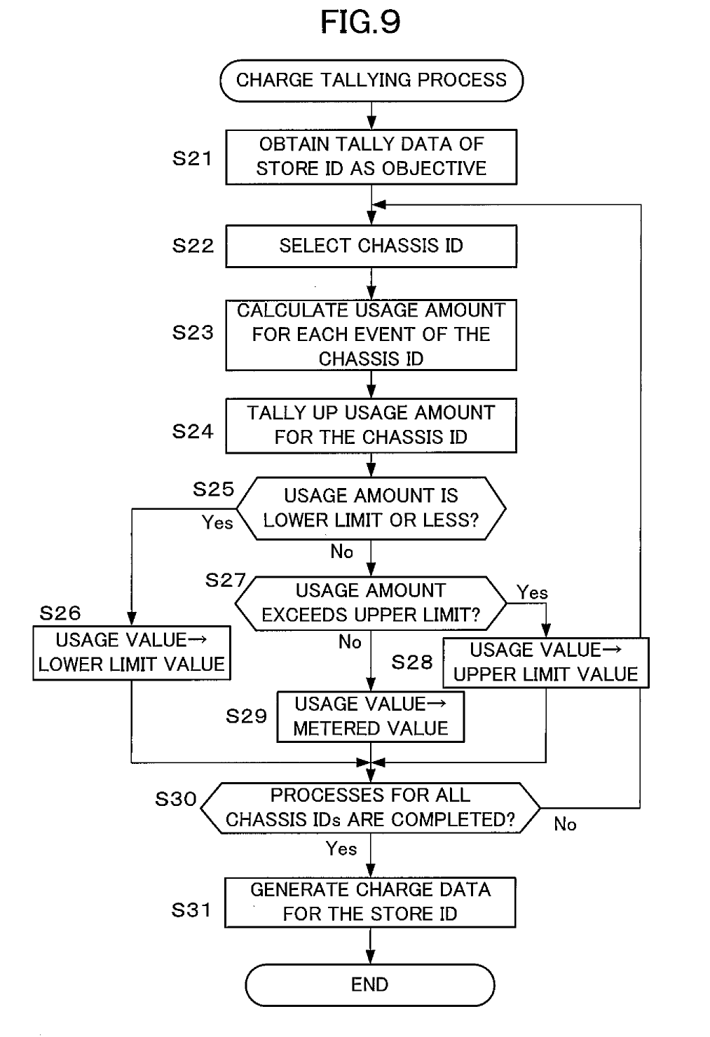

FIG. 9 shows the procedure of the charge tallying process. This process is executed at a predetermined timing (for example, in a case that the deadline is the end of month, midnight time of the beginning of next month) each time the tally period recorded in the tally schedule 213 is elapsed. When starting the charge tallying process, at step S21, the control unit 20 specifies from the ID table 203 the chassis ID corresponding to the store ID as a tallied objective, and obtains the tally data 214 corresponding to the chassis ID obtained. For example, when the store ID “10001” in FIG. 7 is the tallied objective, the chassis IDs correlated with the store ID are specified from the ID table 203, and with respect to each of the chassis IDs, the number of executions of event in the latest tally period for each event is obtained.

Subsequently, at step S22, the control unit 20 selects one chassis ID as a treated objective from the tally data obtained. At step S23, the control unit 20 calculates the usage amount of each event for the chassis ID selected. Namely, the usage amount is calculated by multiplying the unit usage amount of usage amount table 211 (FIG. 5) by the number of executions of the event recorded in the tally data 214. For example, in FIG. 5, as the unit usage amount of the event A1 is set as “5”, in order to calculate the usage amount of June in 2010 of the event A1 with respect to the chassis ID “XXX101” in FIG. 6, the unit usage amount “5” is multiplied by the number of executions “10” and the usage amount of event A1 is determined as “50”.

The calculation in step S23 is executed for all events of the chassis ID selected as the objective. Then, when the calculation is completed, the control unit 20 goes to step S24, and tallies up (totalizes) the usage amount of each event with respect to the chassis ID as the objective. Subsequently, at step S25, the control unit 20 determines whether a tallied usage amount is the lower limit X1 of the usage amount set in the charge setting data 212 or less. In a case that the tallied usage amount is the lower limit X1 or lower, the control unit 20 goes to step S26 to set the usage value of the chassis ID as the lower limit value. On the other hand, at step S25, in a case that the usage amount exceeds the lower limit X1, the control unit 20 goes to step S27 to determine whether the usage amount exceeds the upper limit X2. In a case that the usage amount exceeds, the control unit 20 goes to step S28 to set the usage value of the chassis ID as the upper limit value. On the other hand, at step S27, in a case that the usage amount is the upper limit X2 or lower, the control unit 20 goes to step S29 to set the usage value as a metered value, that is, as a value which exists between the lower limit value and the upper limit value and is determined in accordance with the usage amount.

After the usage value is determined at step S26, S28 or S29, the control unit 20 goes to step S30. At step S30, the control unit 20 determines whether the processes from step S22 up to step S29 are completed or not with respect to all of the chassis IDs correlated with the store ID as the tallied objective. If there is a chassis ID not yet treated, the control unit 20 returns to step S22 to select the chassis ID not yet treated. In a case that it is determined the processes are completed with respect to all of the chassis IDs at step S30, the control unit 20 goes to step S31 to generate the charge data for the store ID as the tallied objective. Namely, the usage amount for each event label, the usage amount totalized for each chassis ID, and the usage value calculated for each totalized usage amount, which are calculated in the above mentioned processes, are recorded in the charge data 215. After that, the control unit 20 terminates the charge tallying process of this time.

Based on the charge data 215 generated in the above mentioned processes, the usage fee of game system 1 (the center server 3) is required regularly from the manager of the game system 1 to the operator of the store 6. The requirement and the collection of fees may be executed by using the game system 1, or may be executed by using a settlement system which is prepared separately from the game system 1. Further, the operator of the store 6 may be allowed to connect a personal computer or the like to the center server 3 via the network 5 so as to refer to the charge data 215 corresponding to his/her own store 6 at arbitrary timing. In this way, the charge data 215 can be used through arbitrary formations.

According to the game system 1 above mentioned, the number of executions is counted for each unit process (event) which is executed selectively by the control unit 20 of the center server 3 in relation to a game, the number of executions counted is converted to the usage amount or the center server 3 by using the weighed value (the unit usage amount) set for each unit process, and the usage fee of the center server 3 is calculated depending on the usage amount for each store 6. Accordingly, it is possible to appropriately reflect it on a charge value of system usage fee to the operator of each store 6 how degree each game machine 2 used service of the center server 3. Further, according to the game system 1, the following effects are also performed.

A flexible fee setting is possible, as the unit usage amount is determined for each unit process. For example, it is possible to change (mark down or mark up) the usage fee in a limited term or not limited term, with respect to a particular unit process set as an objective. Also, by changing the charge setting data 212, it is possible to reconsider the usage fee at arbitrary timing. In a case that the center server 3 provides updated game program or updated data to the game machine 2 in order to add new functions or new modes to a game, it is possible to calculate a system usage fee corresponding to the new functions and the like, only by updating, appropriately for the updated game program or data, the usage amount table 211, the charge setting data 212, the event count table 214, and the charge data 215 included in the charge management data 204.

Further, according to the present invention, it is possible to recognize how degree each event is used if the number of executions of a particular event is tallied up at the center server 3 regardless of the store ID and the chassis ID. For example, in a case that there is an event which is executed in a particular mode of a particular game, if the number of executions of the particular event is tallied up with respect to all game machines 2 or plural game machines 2 extracted as samples set as the objective, it is possible to recognize how often the particular mode is selected by users. The tallied value can be used as an evaluation indicator. Additionally, based on the number of executions of each event, it is possible to reconsider the usage amount table 211.

In the game system 1 above mentioned, the control unit 20 of the center server 3 corresponds to a computer which selectively executes a plurality of unit processes as the charged objectives. The charge management portion 24 provided in the control unit 20 executes the processes in FIG. 8. Thereby, the control unit 20 functions as a count device. The charge management portion 24 executes the processes in FIG. 9. Thereby, the control unit 20 functions as a fee calculation device. However, the present invention is not limited to the above mentioned embodiment, and may be also executed in an arbitrary embodiment. For example, in the above embodiment, the event counting process is executed each time an event as the charged objective is executed at the center server 3. However, in a case that, because of high frequent executions, the reflection on the load of the center server 3 cannot be ignored, the system may be configured so that the number of executions of each event is counted at the game machine 2, and the number of executions of each event (in this case, represented by the number of times the game machine 2 required) is transmitted from the game machine 2 at arbitrary timing so as to be used in the charge tallying process in the center server 3. All processes of the charge tallying process are executed at the center server 3 in the above embodiment. However, in a case that each game machine 2 holds the usage amount table 211, the system may be configured so that the processes from step S22 up to step S24 in FIG. 9 are executed by the control unit 10 of the game machine 2 and the result of the processes is provided to the center server 3. Further, in a case that the game machine 2 holds the charge setting data 212 and the event count table 214, the game machine 2 can execute the processes from step S25 up to step S29 in FIG. 9 in a distributed manner. In a case that the game machine 2 holds the usage amount table 211 and the like, the usage amount table 211 and the like can be distributed to the game machine 2 by the center server 3.

The objective which the present invention is applied to is not limited to a game system using a network. The present invention can be also applied to a game system where a game apparatus is operated in a stand-alone mode. For example, in a case that a game machine is lent to an operator with some usage fee, the usage fee of the game machine can be calculated by the present invention. The intended purpose of the present invention is not limited to the intended purpose to charge a system usage fee for each operator of a store. The group as the charged objective may be set arbitrarily.

1. A game system in which processes to be executed in relation to a game by a computer are capable of be sectioned into a plurality of unit processes each of which is selectively executed, the game system comprising:
a count device adapted and configured to count the number of executions that each of the plurality of unit processes was executed; and
a fee calculation device adapted and configured to calculate, based on a result of count by the count device in a predetermined tally period, a usage fee of the game system in the tally period.

2. The game system according to claim 1, wherein
the fee calculation device is adapted and configured to calculate a usage amount of each unit process in the tally period based on the number of executions of each unit process counted by the count device and weighed value set for each unit process, and calculate the usage fee based on a value tallied up with respect to the usage amount.

3. The game system according to claim 2, wherein
the weighed value is set so that a difference between the unit processes in a load of the computer is compensated for.

4. The game system according to claim 2, wherein
the fee calculation device is adapted and configured to calculate, based on the value tallied up with respect to the usage amount, the usage fee so that the usage fee becomes higher as the value tallied up increases.

5. The game system according to claim 2, wherein
the fee calculation device is adapted and configured to, in a case the value tallied is a predetermined lower limit value of lower of lower, fix the usage fee to the lower limit value, and in a case the value tallied exceeds a predetermined upper limit value, fix the usage fee to the upper limit value.

6. The game system according to claim 1, wherein
the game system includes a game apparatus and a server apparatus connected with each other via a network,
each of the unit processes is a process which a computer of the server apparatus selectively executes by following a requirement from the game apparatus.

7. The game system according to claim 6, wherein
the network is connected with a plurality of game apparatuses,
the count device is adapted and configured to count the number independently of each game apparatus, and
the fee calculation device is adapted and configured to calculate the usage fee for one unit of the game machine.

8. The game system according to claim 7, wherein
the plurality of game apparatuses are installed to each of a plurality of groups as charged objectives, and
the fee calculation device is adapted and configured to tally up the usage fee for each of the plurality of groups.

9. A non-transitory computer readable storage medium storing a computer program for game system being applied to a game system in which processes to be executed in relation to a game by a computer are capable of be sectioned into a plurality of unit processes each of which is selectively executed, the computer program making the computer function as:
a count device adapted and configured to count the number of executions that each of the plurality of unit processes was executed; and
a fee calculation device adapted and configured to calculate, based on a result of count by the count device in a predetermined tally period, a usage fee of the game system in the tally period.

10. A server apparatus for a game system in which processes to be executed in relation to a game by a computer are capable of be sectioned into a plurality of unit processes each of which is selectively executed, the server apparatus comprising:
a count device adapted and configured to count the number of executions that each of the plurality of unit processes was executed; and
a fee calculation device adapted and configured to calculate, based on a result of count by the count device in a predetermined tally period, a usage fee of the game system in the tally period.
